(19) United States
(12) Patent Application Publication
(10) Pub. No.: US 2011/0119244 A1
(43) Pub. Date: May 19, 2011

(54) METHOD FOR FILTERING AND ASSOCIATING TECHNICAL BULLETINS

(76) Inventors: THOMAS H. MILLARD, Akron, OH (US); Glenn J. Millard, Akron, OH (US)

(21) Appl. No.: 12/944,941

(22) Filed: Nov. 12, 2010

Related U.S. Application Data
(60) Provisional application No. 61/260,615, filed on Nov. 12, 2009.

(51) Int. Cl. G06F 17/30

(52) U.S. Cl. 707/706; 707/E17.108

(57) ABSTRACT

A method for diagnosing transmission problems in an automobile is disclosed herein, having the steps of performing a road test on the automobile, wherein the automobile is test driven to determine any potential transmission problems, noting any potential transmission problems, discovered during the road test, on a road test matrix form, wherein the potential transmission problem is noted using a pre-established code, wherein the problems can be further delineated into sub-problems, providing an electronic database containing technical bulletins related to transmission problems, wherein each technical bulletin is associated with at least one of the pre-established codes, entering automobile information into at least one data field, wherein the automobile information is chosen from the group comprising: make, model, year, transmission type, entering at least one code into a database search engine in the electronic database, and providing access to at least one technical bulletin related to at least one potential transmission problem.

This application claims priority to U.S. Ser. No. 61/260,615, entitled Method for Filtering and Associating Technical Bulletins, filed on Nov. 12, 2009, the contents of which are herein incorporated by reference. This invention relates to the art of coordinating, automating, and unifying mechanical repairs, and more particularly to automotive repairs, and even more particularly to transmission repairs, and even more particularly to a universal diagnostic process for transmission repair.

### I. BACKGROUND

ATRA® (Automatic Transmission Rebuilders Association) is an international trade association for automatic transmission repair professionals across North America. It is composed mainly of independent transmission repair facilities. ATRA has a members only online website containing technical bulletins for the repair of transmissions. ATRA also provides a technician hotline which can be contacted with repair questions.

ATSG® (Automatic Transmission Service Group) is a technical support service for the automatic transmission industry. They offer a technical hotline, books, software, bulletins, seminars, and technical courses to automatic transmission professionals. ATSG also has an online database of technical bulletins related to transmission repair.

Currently, across the United States, transmission repair technicians use a variety of terminology to describe transmission repair work, including the diagnosis of the problem. Thousands of technical bulletins exist for repairing transmissions, which are broken down by manufacturer, vehicle type, transmission type, and repair diagnosis. These bulletins are scattered over various websites and other electronic and paper databases.

Query languages are computer languages used to make queries into databases and information systems. A programming language is a machine-readable artificial language designed to express computations that can be performed by a machine, particularly a computer. Programming languages can be used to create programs that specify the behavior of a machine, to express algorithms precisely, or as a mode of human communication.

Broadly, query languages can be classified according to whether they are database query languages or information retrieval query languages. Examples include: .QL is a proprietary object-oriented query language for querying relational databases; Common Query Language (CQL) a formal language for representing queries to information retrieval systems such as web indexes or bibliographic catalogues; CODASYL; CxQL is the Query Language used for writing and customizing queries on CxAudit by Checkmarx; D is a query language for truly relational database management systems (TRDBMS); DMX is a query language for Data Mining models; Datalog is a query language for deductive databases; ERROL is a query language over the Entity-relationship model (ERM) which mimics major Natural language constructs (of the English language and possibly other languages). It is especially tailored for relational databases; Gellish English is a language that can be used for queries in Gellish English Databases, for dialogues (requests and responses) as well as for information modeling and knowledge modeling; ISBL is a query language for PRTV, one of the earliest relational database management systems; LDAP is an application protocol for querying and modifying directory services running over TCP/IP.; MQL is a cheminformatics query language for a substructure search allowing beside nominal properties also numerical properties; MDX is a query language for OLAP databases; OQL is Object Query Language; OCL (Object Constraint Language). Despite its name, OCL is also an object query language and a OMG standard; OPath, intended for use in querying WinFS Stores; Poliqarp Query Language is a special query language designed to analyze annotated text. Used in the Poliqarp search engine; QUEL is a relational database access language, similar in most ways to SQL; SMARTS is the cheminformatics standard for a substructure search; SPARQL is a query language for RDF graphs; SQL is a well known query language for relational databases; SuprTool is a proprietary query language for SuprTool, a database access program used for accessing data in Image/SQL (TurboIMAGE) and Oracle databases; TMQL Topic Map Query Language is a query language for Topic Maps; XQuery is a query language for XML data sources; XPath is a language for navigating XML documents; XSQL combines the power of XML and SQL to provide a language and database independent means to store and retrieve SQL queries and their results.

The most common operation in SQL databases is the query, which is performed with the declarative SELECT keyword. SELECT retrieves data from a specified table, or multiple related tables, in a database. While often grouped with Data Manipulation Language (DML) statements, the standard SELECT query is considered separate from SQL DML, as it has no persistent effects on the data stored in a database. Note that there are some platform-specific variations of SELECT that can persist their effects in a database, such as the SELECT INTO syntax that exists in some databases.

SQL queries allow the user to specify a description of the desired result set, but it is left to the devices of the database management system (DBMS) to plan, optimize, and perform the physical operations necessary to produce that result set in as efficient a manner as possible. An SQL query includes a list of columns to be included in the final result immediately following the SELECT keyword. An asterisk (“*”) can also be used as a “wildcard” indicator to specify that all available columns of a table (or multiple tables) are to be returned. SELECT is the most complex statement in SQL, with several optional keywords and clauses, including: The FROM clause which indicates the source table or tables from which the data is to be retrieved. The FROM clause can include optional JOIN clauses to join related tables to one another based on user-specified criteria; the WHERE clause includes a comparison predicate, which is used to restrict the number of rows returned by the query. The WHERE clause is applied before the GROUP BY clause. The WHERE clause eliminates all rows from the result set where the comparison predicate does not evaluate to True; the GROUP BY clause is used to combine, or group, rows with related values into elements of a smaller set of rows. GROUP BY is often used in conjunction with SQL aggregate functions or to eliminate duplicate rows from a result set; the HAVING clause includes a comparison predicate used to eliminate rows after the GROUP BY clause is applied to the result set. Because it acts on the results of the GROUP BY clause, aggregate functions can be used in the HAVING clause predicate; and the ORDER BY clause is used to identify which columns are used to sort the resulting data, and in which order they should be sorted (options are ascending or descending). The order of rows returned by an SQL query is never guaranteed unless an ORDER BY clause is specified.

The present invention provides a new and improved method for categorizing, systematizing, processing, and retrieving technical bulletins for repair work, and overcomes certain difficulties inherent in the related inventions while providing better overall results.

### II. DEFINITIONS

To assist the reader in understanding the description of this invention, the definitions of the following terms should be noted.

Mechanical Problem—any problem dealing with any component of a vehicle.

Pre-established code—a symbol designated as having a relationship with a particular mechanical problem.

Road test—a test conducted on a vehicle involving driving, or simulated driving, of the vehicle.

Road Test Matrix Form—a form, which can be either paper or electronic, used to record the results of a road test.

Sub-problem—a more specific problem that is encompassed with a broader mechanical problem.

Technical Bulletin—an electronic document detailing one or more mechanical problems or sub-problems.

### III. SUMMARY

In accordance with one aspect of the present invention, a method for diagnosing mechanical repair problems is disclosed herein.

In accordance with another aspect of the present invention, the method includes an electronic database of technical bulletins, or online access to technical bulletins, which are linked to pre-established codes.

In accordance with another aspect of the present invention, a method for diagnosing transmission problems in an automobile includes the steps of performing a road test on the automobile, wherein the automobile is test driven to determine any potential transmission problems, noting any potential transmission problems, discovered during the road test, on a road test matrix form, wherein the potential transmission problem is noted using a pre-established code, wherein the problems can be further delineated into sub-problems, providing an electronic database containing technical bulletins related to transmission problems, wherein each technical bulletin is associated with at least one of the pre-established codes, entering automobile information into at least one data field, wherein the automobile information is chosen from the group comprising: make, model, year, transmission type, entering at least one code into a database search engine in the electronic database, and providing access to at least one technical bulletin related to at least one potential transmission problem.

In accordance with another aspect of the present invention, a searchable electronic system for use with mechanical problems of an associated vehicle includes a processing unit, system memory, an electronic database, at least a first search query field for entering at least one pre-established code related to a potential mechanical problem, multiple technical bulletins related to mechanical problems, the technical bulletins each being associated with the at least one pre-established code, and a search engine for correlating the entered code with the one or more technical bulletin associated with the at least one code.

In accordance with another aspect of the present invention, the system further includes an electronic portal, the portal allowing access to a global computer network, wherein the global computer network contains the technical bulletins.

In accordance with another aspect of the present invention, the system further includes a road test matrix form, wherein the road test matrix form pre-established codes associated with a particular mechanical problem.

In accordance with another aspect of the present invention, wherein the road test matrix form allows electronic data input.

In accordance with another aspect of the present invention, wherein the portal is available via a global computer network.

In accordance with another aspect of the present invention, wherein the vehicle is an automobile, and the mechanical problem is related to transmissions.

In accordance with another aspect of the present invention, wherein the system further comprises and electronic road test matrix form.

In accordance with another aspect of the present invention, wherein the data fields consist of drop-down menus, wherein each code is listed as an option and each transmission type is listed as an option.

In accordance with another aspect of the present invention, a method for diagnosing mechanical problems in a vehicle includes providing an electronic database containing technical bulletins related to mechanical problems, wherein each technical bulletin is associated with at least one pre-established codes, entering vehicle information into at least one data field, entering at least one code into a database search engine in the electronic database, querying the database to match the technical bulletin with the at least one code, and, providing access to at least one technical bulletin related to at least one potential mechanical problem.

In accordance with another aspect of the present invention, wherein the method further includes providing at least a second data field for entering at least one code for a sub-problem and providing at least a third data field for entering a category for the problem.

In accordance with another aspect of the present invention, wherein the category is chosen from the group comprising: minor external, minor internal, and major.

Still other benefits and advantages of the invention will become apparent to those skilled in the art upon a reading and understanding of the following detailed specification.

### IV. BRIEF DESCRIPTION OF THE DRAWING

At least one embodiment of the invention is set forth in the following description and is shown in the drawings and is particularly and distinctly pointed out and set forth in the appended claims.

FIG. 1 shows a road test matrix form;

FIG. 2 shows a screen shot of a search menu from the present invention;

FIG. 3 shows a bulletin filter diagnostics search; and,

FIG. 4 shows an example of a technical bulletin.

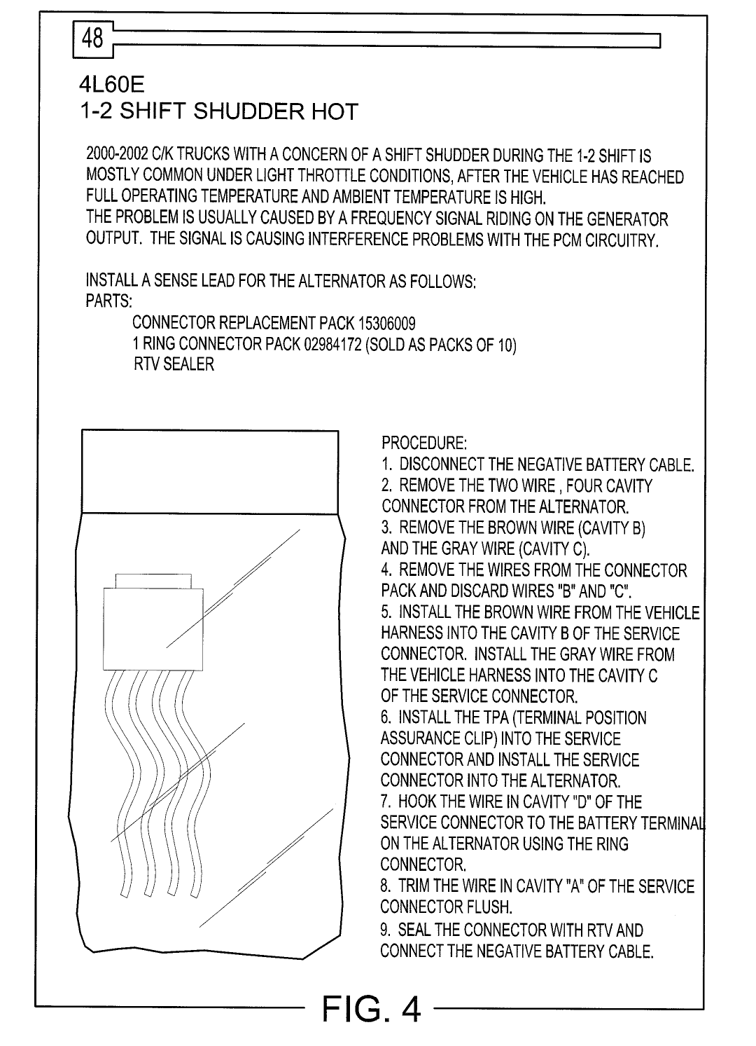

### V. DETAILED DESCRIPTION

The present invention provides a universal road test for diagnosing various mechanical problems, and in several embodiments the mechanical problems are related to automobiles, and in one embodiment, the mechanical problems are related to transmissions. Typically, prior to running a road test, a multi-check is performed, in order to identify concerns and isolate vehicle symptoms. In this embodiment, the multi-check includes a fluid check, a tire check, a shifter check, and diagnostic codes check (if the vehicle has an on-board diagnostic computer system).

In one embodiment, the process begins with a road test of the automobile. The service technician will take the automobile out for a drive and run the automobile through the various functions of the transmission to determine the problems, if any. It is to be understood that the invention contemplates a virtual test drive of the automobile as well, wherein the automobile is driven on a stationary running device, wherein the automobile may be accelerated and shifted without the automobile actually moving forward. The technician will note all of the difficulties that he determines on a road test matrix, which in this embodiment is a paper form (although it is to be understood that the road test matrix could be electronic as well). In one embodiment, when the vehicle is an automobile that is being tested for transmission problems, the road test consists of engagement, automatic upshift (if the vehicle has an automatic transmission), manual upshift (if the vehicle has a manual transmission), forced downshift, engine braking, and coast downshifting (of course, it is to be understood that the road test can include any number of other test features, chosen using sound engineering judgment).

The engagement portion may include the following problems, which are illustrative, and not intended to be exhaustive: delay, park (does not hold park, roll with ratcheting sound, roll before locking and holding), none (no forward or reverse engagement in any gear), harsh (harder than normal engagement), binds (fells like brake is dragging), stalls (engine stalls when forward or reverse gear is selected). The automatic upshift portion may include the following problems, which are illustrative, and not intended to be exhaustive: slip/flair bump (longer than normal time lapse shifting between gears), neutralize (engine free revs after upshifting as if shifted into neutral), shudder/chatter (feels like vibration during the automatic upshift from one gear to another), binds (feels like brake dragging during upshift, engine rpm decrease during upshift, vehicle may lose road speed during upshift), early (upshifts quickly), late (transmission remains in gear too long before upshifting to next gear), hard (upshift from one gear to next is more firm or harsh than normal), hunting/cycling (rapid shifting up and down, searching for gear), skip (bypassing a gear), none/no upshift (does not upshift beyond a certain gear), starts out in (does not start out in first gear). The manual upshift portion may include the following problems, which are illustrative, and not intended to be exhaustive: binds (gear overlap), noise (buzz, whine, knock), vibration. The forced downshift portion may include the following problems, which are illustrative, and not intended to be exhaustive: sensitive (light throttle downshifting to lower gear) and none (no passing gear). The engine braking portion may include the following problems, which are illustrative, and not intended to be exhaustive: none (does not gear down when selecting lower gear) and harsh (clunk or bang when manually selecting lower gear). The coast downshifting portion may include the following problems, which are illustrative, and not intended to be exhaustive: none (after coming to a stop, the vehicle takes off in gear other than first) and hard/harsh (clunk or bang on an automatic downshift slowing down to a stop).

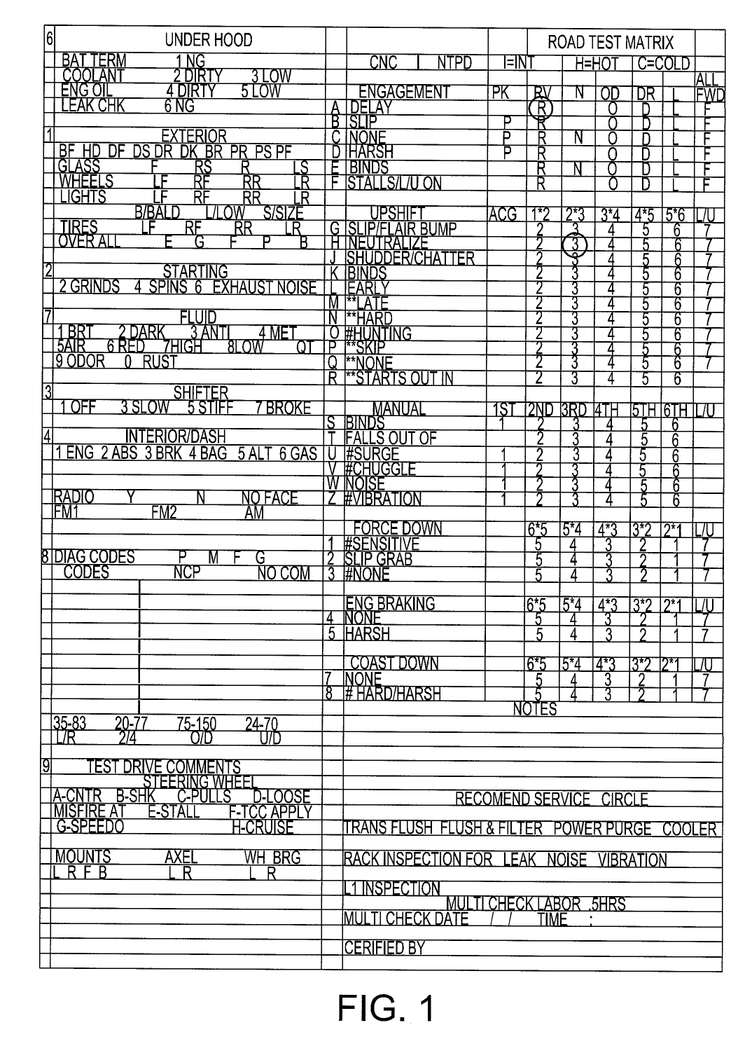

With reference now to FIG. 1, FIG. 1 shows an example of a road test matrix form. This particular embodiment of the form shows various tests run on an automobile transmission, and the various problems that can be encountered. For example, under the heading of UPSHIFT, one of the categories is BINDS. In the columns across from BINDS are the various shifts (i.e. from first to second gear, from second to third gear, etc.) and the individual performing the test can mark the matrix form designating the particular problem. Although in this embodiment, the matrix form is paper, it is to be understood that the matrix form could be entirely electronic, with the tester, for example, utilizing a handheld computer. It is also to be understood that the matrix form could be used for any type of vehicular mechanical problem, and is not limited to automobile transmissions.

With continuing reference to FIG. 1, the road matrix test form provides the various components of the transmission, as well as the various operations of the transmission. As the technician tests the transmission, he notes the result of the test. The result can take the form of a code that is designated for each particular problem. For example, while testing the engagement of an automatic transmission, there is a slip in reverse, the technician could note BR. BR would be a pre-established code meaning a slip in reverse of an automatic transmission. All of the available codes are provided along with the road matrix test, and it is to be understood that any type of code can be used, as long as chosen using sound engineering judgment.

With continuing reference to the road test matrix, in one embodiment, a diagnosed problem can have sub-problems within the problem. Each sub-problem could have a separate code that could be entered on to the matrix separately, or the sub-problem could be directly related to the main problem, so that two codes would be entered on the matrix. In one embodiment, a sub-problem could be found on a drop down menu of the originally diagnosed problem.

With continuing reference to the road test matrix, other tests are shown for various parts of the automobile, along with results/problems from the tests. In one embodiment, the terminology that is used is defined so as to create universality in the repair field. In order to create a system whereby a technician in California can utilize information from a technician in Florida, each technician needs to be using very similar or identical terms to define problems/results. The road test matrix will use and define various terms to define mechanical problems with transmissions (or other areas of an automobile).

In another embodiment of this invention, once the road test matrix is completed, the technician can access an electronic database, which has a catalog of technical bulletins related to mechanical repairs. In one embodiment, the database contains a catalog of technical bulletins related to transmission repair. The technical bulletins are set up in the database to coincide with the codes used on the matrix. Each technical bulletin is associated with at least one of the codes used on the matrix. The bulletins can be associated with multiple codes if applicable. The bulletins will also be associated with particular manufacturers, and particular transmission types, if applicable.

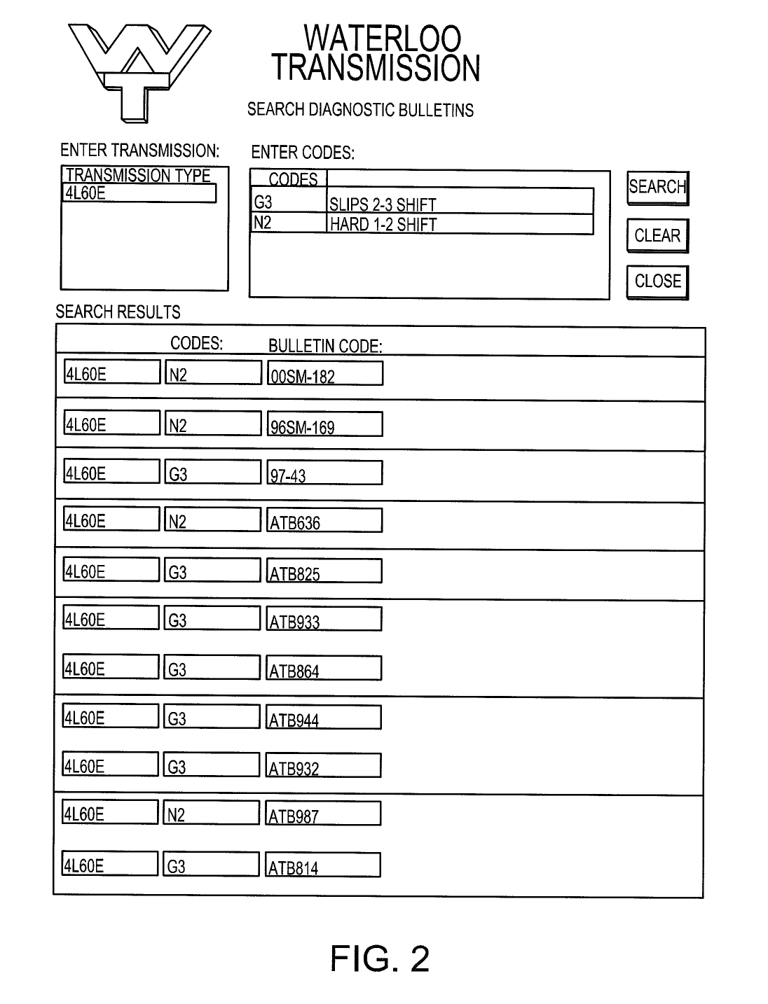

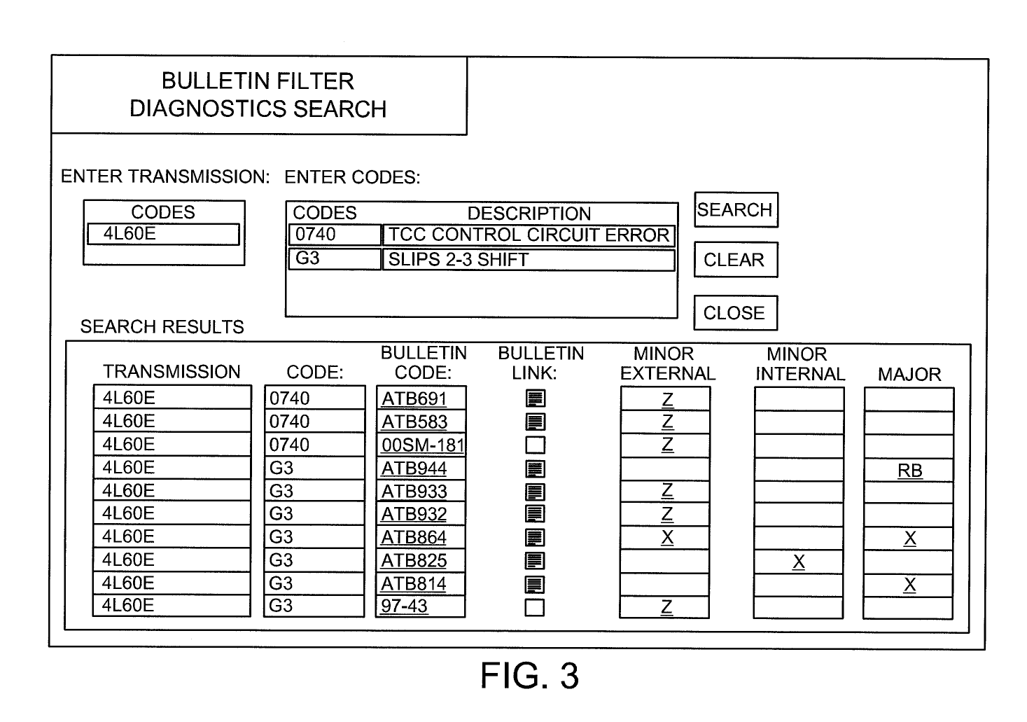

With continuing reference to the database, one example would include a drop down menu, as shown in FIGS. 2 and 3, wherein the available transmission types are available. Another drop down menu would include codes for the diagnosis from the road test matrix. In one embodiment, a second drop down menu could be included for any sub-problems, as discussed earlier. The database has numerous drop down menus to allow for more than one code to be entered. Once the technician has entered all of the relevant information, he hits the search button, and the system provides a list of the technical bulletins available for that transmission type and problem code. In one embodiment, a pdf (portable document format) of the bulletin is available via a click link. It is to be understood, however, that any means of accessing or retrieving the bulletin can be used, as long as chosen using sound engineering judgment. In one embodiment, a computer algorithm is used to search the available technical bulletins, and using the algorithm, associate a code, or codes, with each technical bulletin.

With continuing reference to FIGS. 2 and 3, in one embodiment, the transmission type is entered into a data field, and the problem and/or sub-problem codes are entered into the code field, and after the search is conducted, a bulletin code is shown which contains a bulletin that relates to the particular problem. In one embodiment, as shown in FIG. 3, a link to a pdf of the technical bulletin could be shown and accessed. Also as shown in FIG. 3, one embodiment would have additional codes to further differentiate the problem, such as minor external, minor internal, and major. Once the search has been completed, the technician can click on the link to the technical bulletin and view the bulletin. It is also to be understood that any means of accessing or displaying the technical bulletins can be used, as long as chosen using sound engineering judgment.

In another embodiment, the search of the database would provide a portal to access the website of the organization that has provided the technical bulletin. In this embodiment, access to the technical bulletin could be limited to people who are members of the various organizations that provide technical bulletins. Members of those organizations could enter through the portal and be taken directly to the technical bulletin, which resides on at the website of the organization. Individuals who are not members, who clicked on the link would be taken to the organization's page for becoming a member. The individual would then decide whether accessing that technical bulletin was worth becoming a member of the organization.

Once the technician has pulled up all of the bulletins he would like to review, he can either view the bulletins on the database, print them out, or save them for later viewing. In one embodiment, the bulletins can be saved in a directory by customer, or any other category desired. Once the technician has reviewed all of the bulletins, the technician will then be in a better position to accurately diagnose and fix the problem with the transmission.

In another embodiment, the database search results are arranged in columns In one embodiment, the bulletins are categorized into three columns, Minor External, Minor Internal, and Major. A minor external problem would be a problem external to the transmission, such as an electrical sensor problem. A minor internal problem would be a problem with the transmission, but one that can be repaired without removing the transmission. A major problem is a problem with the transmission, wherein the transmission must be removed for the repair. These columns allow the technician to diagnose smaller problems first, in order to be more efficient and timely in the repair work. It is to be understood that the invention is not limited to having three columns, or the particular columns mentioned in this embodiment, but any number and category of columns can be used, as long as chosen using sound engineering judgment.

The database allows for searches just by transmission type and/or just by code type.

The inventive system includes a computer. The computer may include, but is not limited to, a processing unit, a system memory, and a system bus that couples various system components, including the system memory to the processing unit. The system bus may be any of several types of bus structures and architectures, as is well known in the art. The system memory includes computer storage media in the form of volatile and non-volatile memory such as read-only memory (ROM) and random access memory (RAM). The ROM may include a basic input/output system (BIOS). The RAM may include an operating system, application programs, other program modules, and program data. The computer may include a hard disk drive that reads from or writes to non-removable, non-volatile magnetic media, a magnetic disk drive that reads from or writes to a removable, non-volatile magnetic disk, and an optical disk drive that reads from or writes to a removable, non-volatile optical disk, such as a CD-ROM, digital versatile disks (DVD), or other optical media. The computer may also include magnetic tape cassettes, flash memory cards, digital versatile disks, digital video tape, solid state RAM, and solid state ROM.

The hard disk drive may store the operating system, application programs, other program modules, and program data. A user may enter commands and information into the computer through input devices such as a keyboard and pointing device, commonly referred to as a mouse, trackball, or touch pad. These and other input devices are often connected to the processing unit through a user input interface that is coupled to the system bus, but may be connected by other interface and bus structures, such as a parallel port, game port or a universal serial bus (USB). A monitor or other type of display device is also connected to the system bus via a video interface. A printer or speakers may be connected to the system bus via an output peripheral interface. The system bus may include a network interface for connecting to a computer network (not shown).

The above examples are merely embodiments of the present invention, and are not intended to limit the invention in any manner. It is to be understood that this invention could be utilized with any type of automotive diagnosis. For example, the system would work the same if the diagnosis was related to engines instead of transmissions. It is also to be understood that the invention is not limited to automotive issues, but can be utilized for diagnosis of other types of mechanical and/or electrical problems, such electrical problems in a home or building.

The invention has been described with reference to several embodiments. Obviously, modifications and alterations will occur to others upon a reading and understanding of the specification. It is intended by applicant to include all such modifications and alterations insofar as they come within the scope of the appended claims or the equivalents thereof.

Having thus described the invention, it is now claimed:

What is claimed is:

1. A method for diagnosing transmission problems in an automobile, the method comprising the steps of:
performing a road test on the automobile, wherein the automobile is test driven to determine any potential transmission problems;
noting any potential transmission problems, discovered during the road test, on a road test matrix form, wherein the potential transmission problem is noted using a pre-established code, wherein the problems can be further delineated into sub-problems;
providing an electronic database containing technical bulletins related to transmission problems, wherein each technical bulletin is associated with at least one of the pre-established codes;
entering automobile information into at least one data field, wherein the automobile information is chosen from the group comprising: make, model, year, transmission type;
entering at least one code into a database search engine in the electronic database; and,
providing access to at least one technical bulletin related to at least one potential transmission problem.

2. A searchable electronic system for use with mechanical problems of an associated vehicle, the system comprising:
a processing unit;
system memory;
an electronic database;
at least a first search query field for entering at least one pre-established code related to a potential mechanical problem;
multiple technical bulletins related to mechanical problems, the technical bulletins each being associated with the at least one pre-established code; and,
a search engine for correlating the entered code with the one or more technical bulletin associated with the at least one code.

3. The system of claim 2, wherein the system further comprises:
an electronic portal, the portal allowing access to a global computer network, wherein the global computer network contains the technical bulletins.

4. The system of claim 2, wherein the system further comprises:
a road test matrix form, wherein the road test matrix form pre-established codes associated with a particular mechanical problem.

5. The system of claim 4, wherein the road test matrix form allows electronic data input.

6. The system of claim 3, wherein the portal is available via a global computer network.

7. The system of claim 2, wherein the vehicle is an automobile, and the mechanical problem is related to transmissions.

8. The system of claim 2, wherein the system further comprises and electronic road test matrix form.

9. The system of claim 2, wherein the data fields consist of drop-down menus, wherein each code is listed as an option and each transmission type is listed as an option.

10. A method for diagnosing mechanical problems in a vehicle, the method comprising the steps of:
providing an electronic database containing technical bulletins related to mechanical problems, wherein each technical bulletin is associated with at least one pre-established codes;
entering vehicle information into at least one data field;
entering at least one code into a database search engine in the electronic database;
querying the database to match the technical bulletin with the at least one code; and,
providing access to at least one technical bulletin related to at least one potential mechanical problem.

11. The method of claim 10, wherein the method further comprises the steps of:
providing at least a second data field for entering at least one code for a sub-problem; and,
providing at least a third data field for entering a category for the problem.

12. The method of claim 11, wherein the category is chosen from the group comprising: minor external, minor internal, and major.

13. The method of claim 11, wherein the vehicle is an automobile, wherein the method further comprises the steps of:
performing a road test on the automobile, wherein the automobile is test driven to determine any potential mechanical problems; and,
noting any potential problems, discovered during the road test, on a road test matrix form, wherein the problems can be further delineated into sub-problems.

14. The method of claim 13, wherein the mechanical problems are related to transmissions.

15. The method of claim 14, wherein entering vehicle information into at least one data field further comprises the step of:
entering automobile information into at least one data field, wherein the automobile information is chosen from the group comprising: make, model, year, transmission type.

16. The method of claim 15, wherein the method further comprises the step of:
providing drop-down menus, wherein each code is listed as an option and each transmission type is listed as an option.
